(19) United States
(12) Patent Application Publication
(10) Pub. No.: US 2012/0011977 A1
(43) Pub. Date: Jan. 19, 2012

(54) PAPER TRIMMER WITH PIVOTING CUTTING DEVICE

(75) Inventors: Lisa Singer, Columbus, OH (US); Michael J. Schumacher, Hilliard, OH (US); Scott M. Cline, Columbus, OH (US); Dana J. Koppes, Columbus, OH (US); Michael A. Lorenz, Columbus, OH (US)

(73) Assignee: ELMER'S PRODUCTS, INC., Columbus, OH (US)

(21) Appl. No.: 13/004,053

(22) Filed: Jan. 11, 2011

Related U.S. Application Data
(60) Provisional application No. 61/293,779, filed on Jan. 11, 2010.

(51) Int. Cl. B26D 1/18; B26D 7/26

(52) U.S. Cl. 83/471.2

(57) ABSTRACT

A paper trimmer that includes a base having a paper cutting device pivotally attached to the base for providing a variable, user-determined cut angle. The cutting device further includes at least one guide rail; a blade carrier slidably mounted on the guide rail; at least one cutting blade retractably mounted within the blade carrier; a translucent paper holder positioned lengthwise beneath the guide rail, wherein one edge of the translucent paper holder is adjacent to the cutting blade; an illumination strip mounted on top of the translucent paper holder for illuminating the edge of the paper holder adjacent to the cutting blade; and a handle assembly mounted on the guide rail. The handle assembly further includes a first locking mechanism for holding the cutting device at a user-determined cut angle, and a second locking mechanism for raising or lowering the cutting device relative to the upper surface of the base.

This patent application claims the benefit of U.S. Provisional Patent Application Ser. No. 61/293,779, filed on Jan. 11, 2010 and entitled “Rotary Paper Trimmer”, the disclosure of which is hereby incorporated by reference herein in its entirety and made part of the present U.S. utility patent application for all purposes.

### BACKGROUND OF THE INVENTION

The described invention relates in general to systems and devices for cutting and trimming paper and similar materials, and more specifically to a paper trimmer that includes a pivoting cutting device that permits a user of the paper trimmer to select a desired cut angle.

Rotary paper trimmers are fairly common items that are commercially available from different sources. However, current rotary paper trimmers are typically configured to provide a user of the trimmer with only a single cutting angle. While generally useful, such paper trimmers suffer from inherent limitations due to this single cutting angle. Accordingly, there is an ongoing need for a trimmer that provides a user with a variety of choices with regard to the angle at which a piece of paper or other material may be cut.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a paper trimmer is provided. This paper trimmer includes a base having a paper cutting device pivotally attached to the base for providing a variable, user-determined cut angle.

In accordance with another aspect of the present invention, a paper trimmer is provided. This paper trimmer includes a base having a paper cutting device pivotally attached to the base for providing a variable, user-determined cut angle. The cutting device further includes at least one guide rail; a blade carrier slidably mounted on the guide rail; at least one cutting blade mounted within the blade carrier; a translucent paper holder positioned lengthwise beneath the guide rail, wherein one edge of the translucent paper holder is adjacent to the cutting blade; and an illumination strip mounted on top of the translucent paper holder for illuminating the edge of the paper holder adjacent to the cutting blade.

In yet another aspect of this invention, a rotary paper trimmer is provided. This rotary paper trimmer includes a base having a paper cutting device pivotally attached to the base for providing a variable, user-determined cut angle. The cutting device further includes at least one guide rail; a blade carrier slidably mounted on the guide rail; at least one cutting blade retractably mounted within the blade carrier; a translucent paper holder positioned lengthwise beneath the guide rail, wherein one edge of the translucent paper holder is adjacent to the cutting blade; an illumination strip mounted on top of the translucent paper holder for illuminating the edge of the paper holder adjacent to the cutting blade; and a handle assembly mounted on the guide rail. The handle assembly further includes a first locking mechanism for holding the cutting device at a user-determined cut angle, and a second locking mechanism for raising or lowering the cutting device relative to the upper surface of the base.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a front perspective view of an exemplary embodiment of a rotary paper cutter, in accordance with the present invention;

FIG. 2 is a top view of the rotary paper cutter of FIG. 1 shown with the cutting device partially rotated and the storage drawer in the open position;

FIG. 3 is a bottom view of the rotary paper cutter of FIG. 1;

FIG. 4A is a right side view of the rotary paper cutter of FIG. 1 shown with the lever for the locking mechanism that holds the cutting device at a user-determined cut angle in the raised position;

FIG. 4B is a right side cross-sectional view of the rotary paper cutter of FIG. 1 shown at the center of the cutting device;

FIG. 5 is an exploded front perspective view of the rotary paper cutter of FIG. 1 showing the various components thereof;

FIG. 6 is a bottom view of the cutting device of the rotary paper cutter of FIG. 1 shown with the illumination strip on and illustrating the direction of the light emitted by the LEDs mounted within the illumination strip;

FIG. 7 is an exploded view of a portion of the handle assembly of the rotary paper cutter of FIG. 1;

FIG. 8 is an exploded view of the blade carrier of the rotary paper cutter of FIG. 1 shown with the blade cartridge removed from the blade carrier; and

FIG. 9 is an exploded view of a portion of the cutting device of the rotary paper cutter of FIG. 1 showing the biasing members and switch component thereof.

### DETAILED DESCRIPTION OF THE INVENTION

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention. As previously stated, the present invention relates generally to a paper trimmer that includes a pivoting cutting device that permits a user of the paper trimmer to select a desired cut angle. With reference now to the Figures, one or more specific embodiments of this invention shall be described in greater detail.

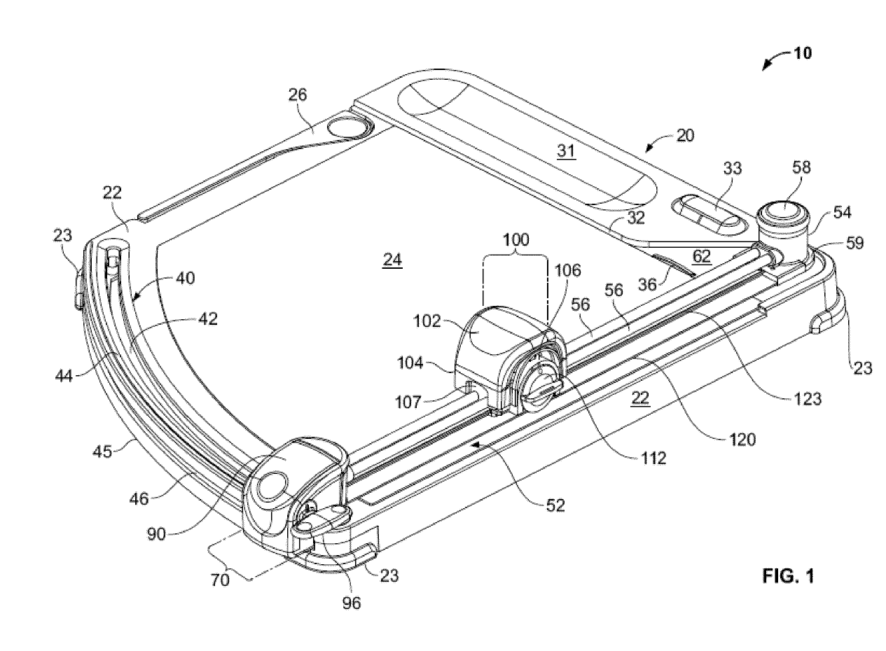

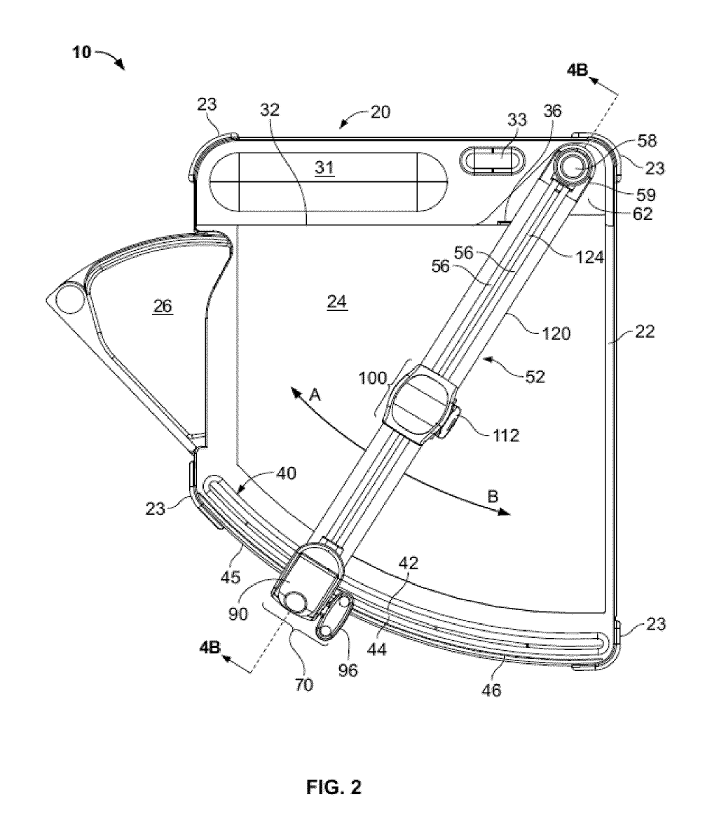

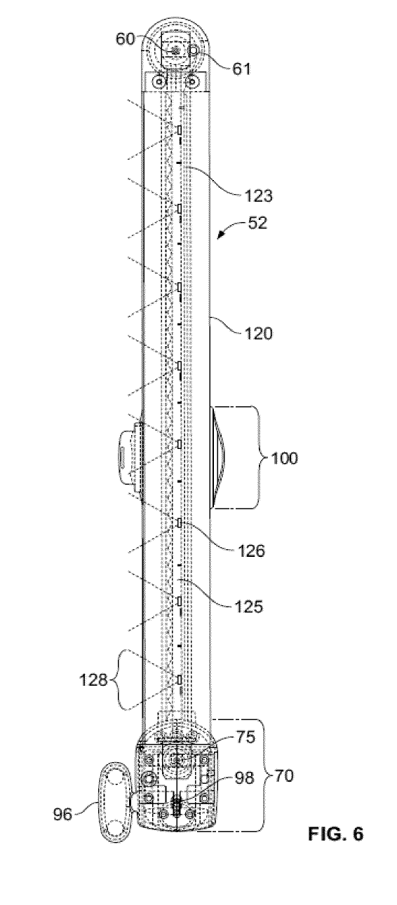

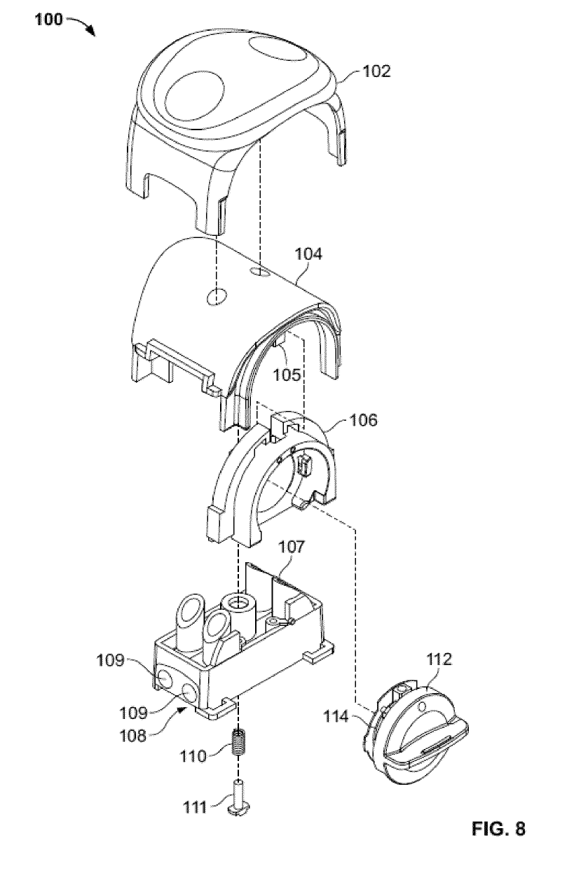

FIGS. 1-9 provide various illustrative views of an exemplary embodiment of paper trimmer 10. Although the present device is referred to as a paper trimmer, those of ordinary skill in the art will appreciate that the described device may be used to cut and trim not only paper, but also other suitable materials. As best shown by FIGS. 1-2, paper trimmer 10 includes base 20 and cutting device 50. In this embodiment, cutting device 50 is attached to base 20 at a single pivot point in the upper right-hand corner of the trimmer. Attaching cutting device 50 to base 20 in this manner, allows a user of trimmer 10 to rotate cutting device 50 forward and backward along a predetermined arc path, as shown by arrows A and B in FIG. 2. This rotational movement permits the user of trimmer 10 to select one or more specific cut angles at which paper may be trimmed.

With reference to FIGS. 1-3, base 20 includes a frame 22, which is typically molded plastic or polymer, that further includes four corner supports 23 that rest upon a surface upon which paper trimmer 10 has been placed. Rubberized feet caps 49 provide additional support and stability. Plastic cutting mat 24 is mounted within frame 22 and includes a series of guide lines in the form of (i) a grid; (ii) indicators of common cutting angles such as 22.5°, 30°, and 45°; and (iii) indicators of common paper sizes such as 4″×6″, 5″×7″, 8″×10″, and 8.5″×11″. Alternate indicators of size and orientation are possible with other embodiments of this invention.

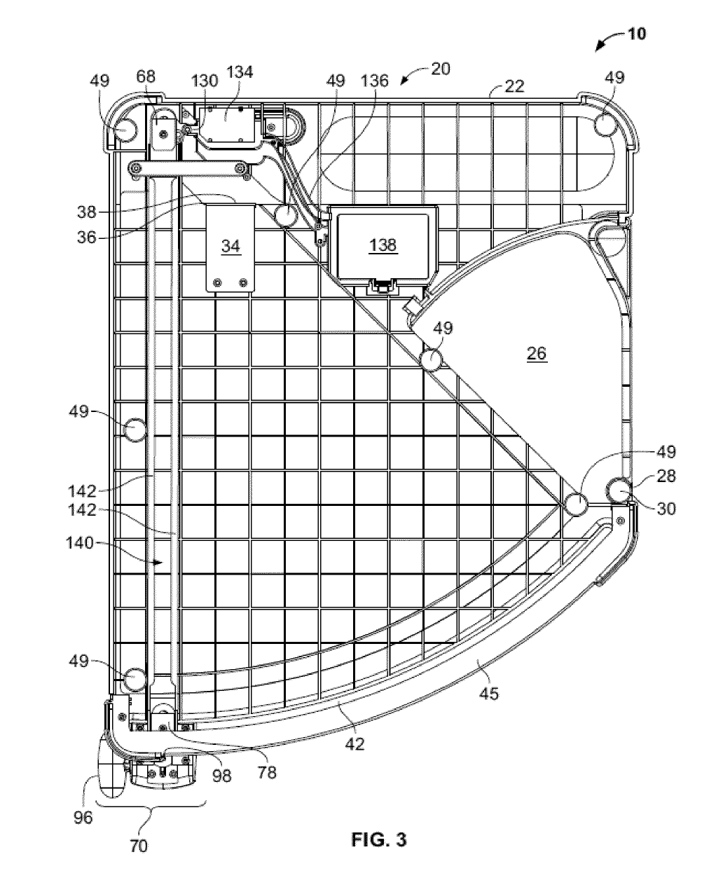

Base 20 further includes storage drawer 26, which is rotatably attached to base 20 at pivot 28, which is covered with cap 30. Recess 31 is formed in the top surface of base 20 for providing additional storage for items such as pens or paperclips. Region 62 (see FIGS. 1-2) defines the area in which cutting device 50 may freely rotate. A raised edge provides a fixed paper guide 32 along the top portion of the upper surface of base 20 and in some embodiments, logo plate 33 is provided for identification of the commercial source of paper trimmer 10. As best shown in FIGS. 1 and 3, spring-loaded paper guide 34, which includes tab 36 extending through slot 38, serves as an extension of fixed paper guide 32, when cutting device 50 is in shallow angle positions close to 0° (i.e., perpendicular to the paper guides). When cutting device 50 is rotated to larger angles, paper holder 120 depresses spring-loaded paper guide 34 into base 20 to avoid interference with cutting. Spring-loaded paper guide 34 is not necessary at larger cutting angles as cutting device 50 is closer positionally to fixed paper guide 32.

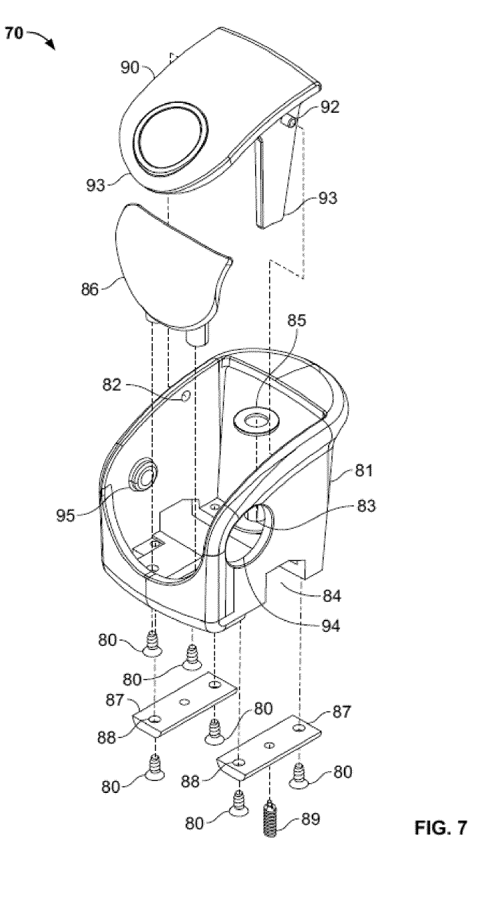

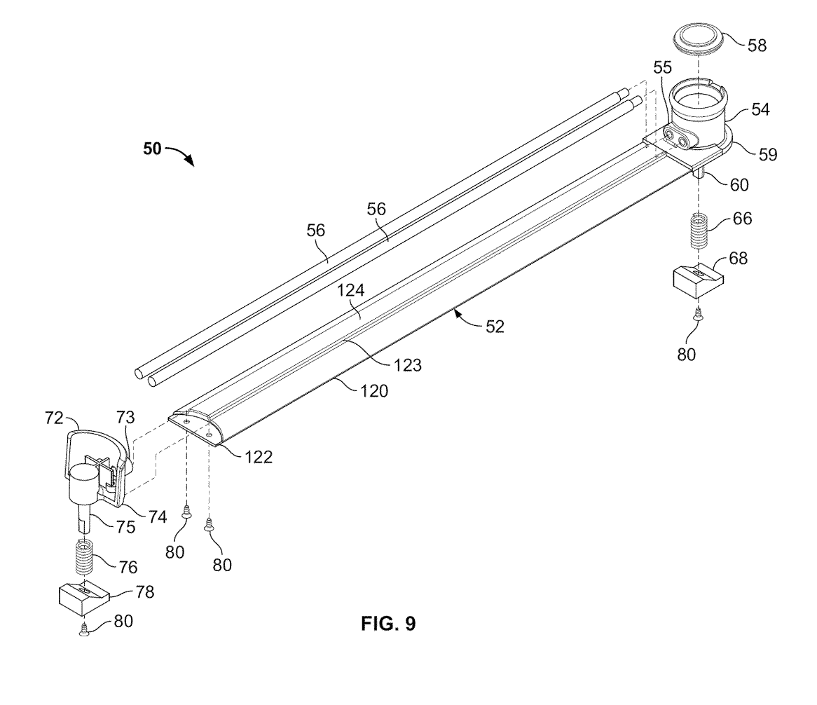

Again with reference to FIGS. 1-3, base 20 further includes track 40 formed in the front edge thereof for cooperating with handle assembly 70 during cutting. Track 40 further includes open channel 42, which receives slider post 75 (see FIG. 9), and front edge 44, which engages slider housing 81 (see FIG. 7). Track base 45 is connected to frame 22 and forms slot 46 therewith for receiving and cooperating with slider plates 87 (see FIG. 7). A curved metal plate 47 (not shown) is attached to the underside of front edge 44 and includes a series of detents 48 (not shown) that are engaged by spring 89 (see FIG. 7) to stop rotation of cutting device 50 at predetermined cutting angles.

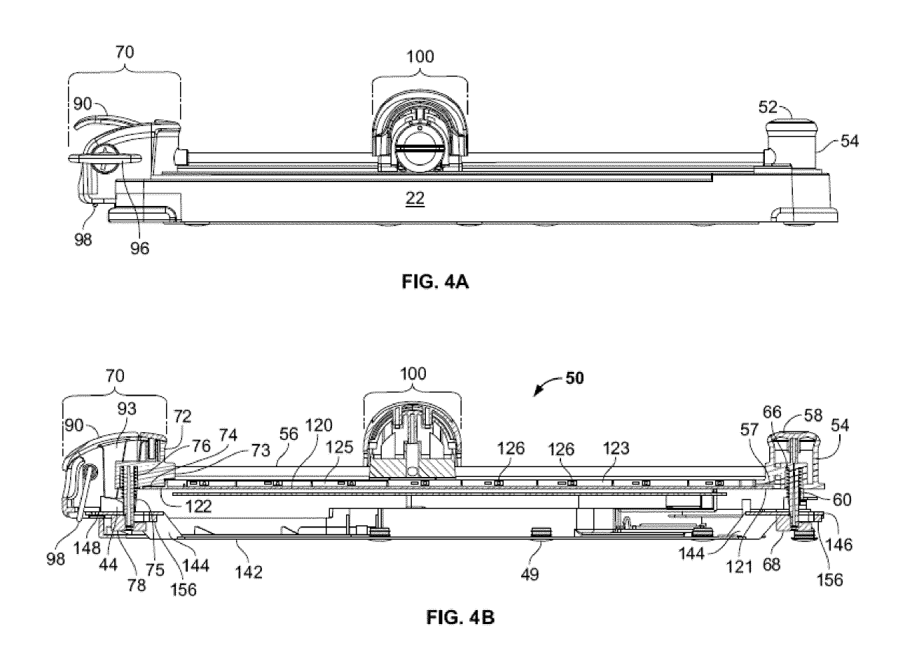

As best shown in FIGS. 4-9, and with reference to FIGS. 1-9, cutting device 50 includes a number of components involved in the cutting process. These components include handle assembly 70, blade carrier 100, and the “floating” support on which these components are mounted. With reference to FIG. 9, one end of floating support 52 includes pivot spindle 54, which further includes port 55. Two guide rails 56 are inserted into apertures formed in port 55 for supporting blade carrier 100. Channel 57 (see FIG. 4B) is formed in base portion 59 of pivot spindle 54 for receiving first end 121 of paper holder 120 and depressing switch 130, as described below with regard to illumination strip 123. Cap 58 is inserted into the top portion of pivot spindle 54 and is in contact with or formed as part of post 60, which passes through spring 66 and is connected to wedge 68 by a connector 80. Conduit 61 (not shown) is formed in pivot spindle 54 and provides a passage for wiring to pass through opening 64, which is formed in base 20. Spring 66 biases pivot spindle 54 upward and provides a portion of the “floating” aspect of support 52.

With reference to FIGS. 1, 3, 4B, and 6, Paper holder 120 is a translucent material that includes first end 121, which is connected to pivot spindle 54 and second end 122, which is connected to handle spindle 72. Illumination strip 123, which is formed from the same material as paper holder 120, and cover 124 enclose PCB strip 125, which includes a plurality of LEDs 126 mounted thereon. The side of illumination strip 123 that faces cutting blade 114 includes a strip of material formed in a zigzag pattern to reflect the light of the LEDs in direction 128 to indicate the position of the cut. Illumination strip 123 is activated by pushing down on cap 58 and pivot spindle 54, thereby contacting switch 130, the top portion of which extends through base 20. The bottom portion of switch 130 engages controller 134 (see FIG. 3), which includes the various electronics that provide power to LEDs 126. Controller 134 also includes a delay timer that turns the LEDs off after a predetermined period of time to conserve battery power. Power supply 138 typically includes a compartment for AA or other batteries, and enclosure 136 houses the electrical wiring that extends between power supply 138 and controller 134.

As best shown in FIGS. 4A-B, 7 and 9, handle assembly 70 further includes handle spindle 72, which also includes port 73 for receiving the other ends of guide rails 56. Channel 74 is formed in handle spindle 72 for receiving second end 122 of paper holder 120. Post 75 is a component of handle spindle 72 and passes through spring 76 and is connected to wedge 78 by a connector 80. Spring 76 biases handle spindle 72 upward and provides a portion of the “floating” aspect of support 52. With reference to FIG. 7, handle assembly 70 further includes housing 81, the front portion of which is enclosed with cover 86. Housing 81 further includes apertures 82, which are adapted to receive pins 92 formed on both sides of locking lever 90. Aperture 83 is formed in the bottom, rear portion of housing 81 and is adapted to receive, in combination with washer 85, post 75 on handle spindle 72. Channel 84 is formed in the bottom edge of housing 81 and engages front edge 44 (see FIG. 1) as cutting device 50 is rotated. Stabilizer plates 87 extend through slot 46 and are attached to the bottom surface of housing 81 across channel 84 by passing connectors 80 through plate apertures 88. A spring loaded pin 89 is inserted through one of the stabilizer plates 87 for engaging detents 48. Locking lever 90 is mounted within housing 81 and is used to secure handle assembly 70 at a user-defined angle along the arc path followed by cutting device 50. Locking lever 90 also includes lock tabs 93, which engage a narrow ridge formed on the top surface of front edge 44 and lock handle assembly 70 in place when locking lever 90 is completely depressed.

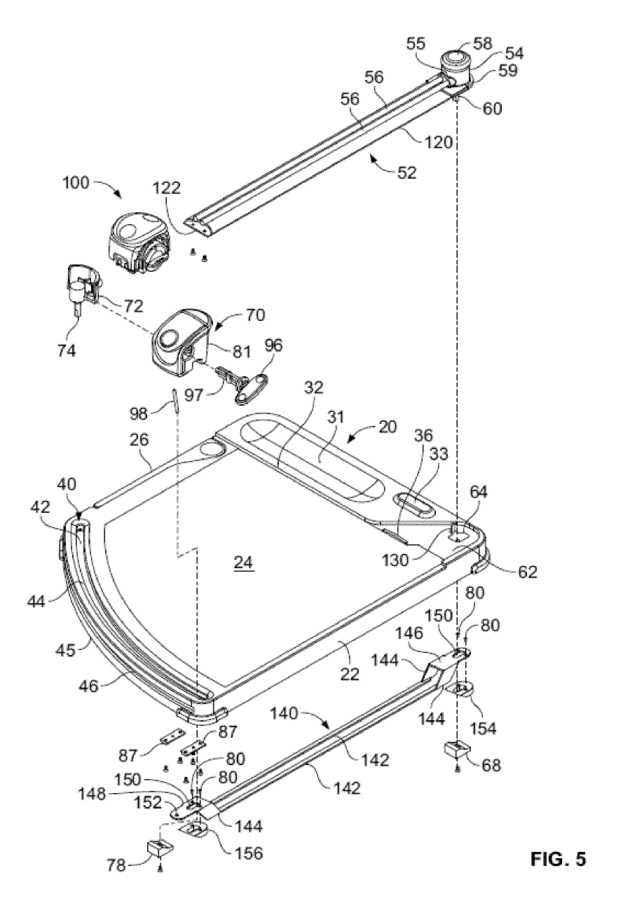

Aperture 94 is formed in one side of housing 81 and port 95 is formed in the opposite side of housing 81. As shown in FIG. 5, shaft 97 passes through aperture 94 and rests in port 95. Handle 96 is formed at the end of shaft 97 and pin 98 is secured to shaft 97. Pin 98 extends through a slot in the bottom of housing 81 where it engages one end of lock bar 140, which extends across the bottom surface of base 20 (see FIGS. 3 and 5). Rotation of handle 96 away from the user of paper trimmer 10 moves pin 98 forward, thereby causing lock bar 140 to move forward into a locked position. This forward movement of lock bar 140 exerts downward pressure on wedges 68 and 78, which overcomes the upward force of springs 66 and 76 and causes the entire cutting device 50 to be lowered onto the upper surface of base 20. Lowering cutting device 50 in this manner basically immobilizes paper or other material that has been placed under paper holder 120. As shown in FIG. 5, lock bar 140 includes elongated bottom members 142, each of which terminates in an offset arm 144 that is formed integrally with either first flat portion 146 or second flat portion 148, both of which include a slot 150. The slot 150 that is formed in first flat portion 146 receives post 60, and the slot 150 that is formed in second flat portion 148 receives post 75. Aperture 152 is formed in second flat portion 148 and receives pin 98. Wedge 154 is attached to the bottom surface of lock bar 140 and engages wedge 68 (described above), while wedge 156 is attached to the bottom surface of lock bar 150 and engages wedge 78 (described above). These structures cooperate with one another to raise or lower paper holder 120 based on the position of handle 96.

With reference to FIGS. 4A-B and 8, blade carrier 100 includes a rounded plastic cover 102, which is attached to housing 104. Housing 104 includes plunger 105, which when depressed (by pressing down on cover 102) passes through carriage 106 and engages blade cartridge 112 for lowering spring-loaded rotary cutting blade 114 against a material to be cut. As a safety feature, blade 114 automatically retracts into blade cartridge 112 when downward force is removed from cover 102. Blade cartridge 112 is removable from carriage 106 by rotating the cartridge counterclockwise. Similarly, a replacement blade cartridge 112 may be installed by placing the cartridge in carriage 106 and turning the cartridge clockwise until it snaps into place. The bottom portion of slider 107 includes channel 108 that engages the top edge of illumination strip 123, and bores 109 receive guide rails 56 therein. Housing 104 is connected to slider 107, which allows the entire assembly to move freely forward and backward along guide rails 56 and top portion of illumination strip 123. Screw 111 connects spring 110 to housing 104 for biasing housing 104 and cover 102 upward when paper trimmer 10 is not in use.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept. Various other embodiments of the present invention that include numerous different structural components and features are possible.

What is claimed:

1) A paper trimmer, comprising:
(a) a base, wherein the base further includes an upper surface and a lower surface; and
(b) a paper cutting device pivotally attached to the upper surface of the base for providing a variable, user-determined cut angle.

2) The paper trimmer of claim 1, wherein the base further includes a cutting substrate on the upper surface thereof, and wherein the cutting substrate further includes visual indications of various cutting angles.

3) The paper trimmer of claim 1, wherein the base further includes a storage drawer.

4) The paper trimmer of claim 1, wherein the paper cutting device further includes at least one guide rail; a blade carrier slidably mounted on the at least one guide rail; and at least one cutting blade mounted within the blade carrier.

5) The paper trimmer of claim 4, wherein the at least cutting blade is housed within a blade cartridge, and wherein the blade cartridge is removable from the blade carrier.

6) The paper trimmer of claim 4, wherein the paper cutting device further includes a translucent paper holder positioned lengthwise beneath the at least one guide rail, and wherein one edge of the translucent paper holder is adjacent to the cutting blade.

7) The paper trimmer of claim 6, wherein the paper cutting device further includes an illumination strip mounted on top of the translucent paper holder for illuminating the edge of the translucent paper holder adjacent to the cutting blade, and wherein the illumination strip further includes at least one light-emitting element.

8) The paper trimmer of claim 7, wherein the paper cutting device further includes a depressible switch for activating the illumination strip.

9) The paper trimmer of claim 4, wherein the paper cutting device further includes a handle assembly mounted on the at least one guide rail, wherein the handle assembly further includes a first locking mechanism for holding the paper cutting device at a user-determined cut angle, and a second locking mechanism for raising or lowering the paper cutting device relative to the upper surface of the base.

10) The paper trimmer of claim 9, wherein the base further includes a track having a plurality of detents at positions corresponding to predetermined cutting angles, and wherein the detents cooperate with the handle assembly to stop rotation of the cutting device at the predetermined cutting angles.

11) A paper trimmer, comprising:
(a) a base, wherein the base further includes an upper surface and a lower surface; and
(b) a paper cutting device pivotally attached to the upper surface of the base for providing a variable, user-determined cut angle, wherein the paper cutting device further includes:
(i) at least one guide rail;
(ii) a blade carrier slidably mounted on the at least one guide rail;
(iii) at least one cutting blade mounted within the blade carrier;
(iv) a translucent paper holder positioned lengthwise beneath the at least one guide rail, wherein one edge of the translucent paper holder is adjacent to the cutting blade; and
(v) an illumination strip positioned on top of the translucent paper holder for illuminating the edge of the translucent paper holder adjacent to the cutting blade, wherein the illumination strip further includes at least one light-emitting element.

12) The paper trimmer of claim 11, wherein the base further includes a cutting substrate on the upper surface thereof, and wherein the cutting substrate further includes visual indications of various cutting angles.

13) The paper trimmer of claim 11, wherein the base further includes a storage drawer.

14) The paper trimmer of claim 11, wherein the at least one cutting blade is a rotary blade.

15) The paper trimmer of claim 11, wherein the at least cutting blade is housed within a blade cartridge, and wherein the blade cartridge is removable from the blade carrier.

16) The paper trimmer of claim 11, wherein the paper cutting device further includes a depressible switch for activating the illumination strip.

17) The paper trimmer of claim 11, wherein the paper cutting device further includes a handle assembly mounted on the at least one guide rail, wherein the handle assembly further includes a first locking mechanism for holding the paper cutting device at a user-determined cut angle, and a second locking mechanism for raising or lowering the paper cutting device relative to the upper surface of the base.

18) The paper trimmer of claim 17, wherein the base further includes a track having a plurality of detents at positions corresponding to predetermined cutting angles, and wherein the detents cooperate with the handle assembly to stop rotation of the cutting device at the predetermined cutting angles.

19) A paper trimmer, comprising:
(a) a base, wherein the base further includes an upper surface and a lower surface; and
(b) a paper cutting device pivotally attached to the upper surface of the base for providing a variable, user-determined cut angle, wherein the paper cutting device further includes:
(i) at least one guide rail;
(ii) a blade carrier slidably mounted on the at least one guide rail;
(iii) at least one cutting blade retractably mounted within the blade carrier;
(iv) a translucent paper holder positioned lengthwise beneath the at least one guide rail, wherein one edge of the translucent paper holder is adjacent to the cutting blade;
(v) an illumination strip positioned on top of the translucent paper holder for illuminating the edge of the translucent paper holder adjacent to the cutting blade, wherein the illumination strip further includes at least one light-emitting element; and
(vi) a handle assembly mounted on the at least one guide rail, wherein the handle assembly further includes a first locking mechanism for holding the paper cutting device at a user-determined cut angle, and a second locking mechanism for raising or lowering the paper cutting device relative to the upper surface of the base.

20) The paper trimmer of claim 19, wherein the base further includes a cutting substrate on the upper surface thereof, and wherein the cutting substrate further includes visual indications of various cutting angles.

21) The paper trimmer of claim 19, wherein the base further includes a storage drawer.

22) The paper trimmer of claim 19, wherein the at least one cutting blade is a rotary blade.

23) The paper trimmer of claim 19, wherein the at least cutting blade is housed within a blade cartridge, and wherein the blade cartridge is removable from the blade carrier.

24) The paper trimmer of claim 19, wherein the paper cutting device further includes a depressible switch for activating the illumination strip.

25) The paper trimmer of claim 19, wherein the base further includes a track having a plurality of detents at positions corresponding to predetermined cutting angles, and wherein the detents cooperate with the handle assembly to stop rotation of the cutting device at the predetermined cutting angles.
